(19) United States
(12) Patent Application Publication
(10) Pub. No.: US 2019/0087794 A1
(43) Pub. Date: Mar. 21, 2019

(54) DONGLE SYSTEM FOR PROVIDING INTERNET OF THINGS SERVICE

(71) Applicant: Yong Jin CHO, Seongnam-si (KR)

(72) Inventor: Yong Jin CHO, Seongnam-si (KR)

(21) Appl. No.: 16/083,505

(22) PCT Filed: Feb. 28, 2017
(86) PCT No.: PCT/KR2017/002189

§ 371 Date: Sep. 8, 2018

(30) Foreign Application Priority Data
Mar. 29, 2016 (KR) 10-2016-0037594

(51) Int. Cl. G06Q 20/08; G06Q 20/16; G06Q 20/32; G06F 8/65

(52) U.S. Cl. CPC G06Q 20/085; G06F 8/65; G06Q 20/3278; G06Q 20/16

(57) ABSTRACT

An example of the present invention provides a dongle system including a dongle terminal, the dongle terminal comprising: a dongle terminal unit including a dongle data terminal for data communication with an external product, a dongle power terminal for receiving power supply from the external product, and a dongle antenna terminal for connection with an antenna unit which is installed in the external product and is wirelessly connected to an external server and the Internet of things; a dongle data communication processing unit connected with the dongle data terminal so as to process data communication with the external product; a wireless communication processing unit connected with the dongle antenna terminal so as to process wireless communication with the external server, and to receive, from the external server, a first product control signal for providing an Internet of things service to the external product; and a product service software unit having dongle software installed therein, processing the first product control signal received through the wireless communication processing unit and transmitting the same to the dongle data communication processing unit, and transmitting, to the dongle data communication processing unit, a second product control signal which is generated through the dongle software so as to control the external product.

### TECHNICAL FIELD

The present invention relates to a dongle system for providing Internet of Things services.

### DESCRIPTION OF THE RELATED ART

In recent years, the Internet of Things (IoT) has been widely distributed such that many people may use the IoT. Wired and wireless communication modules are used to turn products, not connected to the Internet, to the ones connected to the Internet.

Wired and wireless communication modules are integrated into products such that the products may be connected to the Internet (e.g. a communication module is integrated into a computer, a smart phone etc.). In this case, the price of such products rises. Customers do not feel inclined to purchase a product connected to the IoT because they do not think the perceived benefits of IoT services is high. Accordingly, manufacturers are not willing to produce IoT products, and IoT products are not available in the market. This has put a damper on progress in IoT services.

Meanwhile, if a communication module is made into a dongle, a customer can separately purchase a dongle such that the dongle connects with a specific product and that the product connects with the Internet through the dongle. In this case, there is no large increase in the price of such products, and a manufacturer can meet the needs of customers who want internet access and those who do not with one product.

Such a dongle mediates between a product and an Internet service, and an IoT service corresponding to a dongle is applied to an IoT product according to the dongle inserted into the IoT product. For instance, if a service dongle of A company is inserted into a product, a service of A company is applied to the product, and if a service dongle of B company is inserted into a product, a service of B company is applied to the product.

A proper size of antenna is necessary for a conventional dongle so as to smoothly perform wireless communication and has to be positioned at the front of a product so as to transmit and receive radio waves. In this case, the size of a dongle increases, thereby making product design unpleasant. Accordingly, it is difficult to apply a dongle to home appliances.

Further, in the case of conventional non-IT products that are not connected to the Internet, problems such as CPU power etc. put limits to the processing of wired and wireless communication. Accordingly, a dongle processes all the wired and wireless communication and communicates with a product. In this case, software dependent on a specific product and service has to be mounted onto a dongle.

As a result, a conventional dongle can be used only for a specific product and service. This leads to a limit to the sale of a dongle. For instance, a dongle for connecting an electronic good of A company with a smart home service of A company was launched but didn't sold well because the dongle could be used only for a specific product and service.

### DETAILED DESCRIPTION OF THE INVENTION

### Technical Problems

The present invention is directed to providing a dongle system including a dongle which is minimized in size and independent from IoT products and IoT services.

### Technical Solutions

A dongle system according to an embodiment of the present invention includes a dongle terminal, the dongle terminal including: a dongle terminal unit including a dongle data terminal for data communication with an external product, a dongle power terminal receiving power from the external product, and a dongle antenna terminal connecting with an antenna unit which is installed in the external product, wirelessly connects with an external server and the IoT, and receives a first product control signal from the external server so as to provide IoT services to the external product; a dongle data communication processing unit connecting with the dongle data terminal so as to process data communication with the external product; a wireless communication processing unit connecting with the dongle antenna terminal so as to process wireless communication with the external server and to receive the first product control signal; a product service software unit having a space for dongle software therein, connecting with the wireless communication processing unit, processing the first product control signal according to dongle software so as to transmit the same to the dongle data communication processing unit, generating a second product control signal on the basis of the dongle software so as to control the external product, and transmitting the second product control signal to the dongle data communication processing unit; and an installation unit downloading dongle software appropriate for the external product from the external server and installing the same in the product service software unit.

Additionally, the dongle system further includes a product connecting with the dongle terminal unit, wherein the product may include a product terminal unit including a product data terminal connecting with the dongle data terminal, a product power terminal connecting with the dongle power terminal and a product antenna terminal connecting with the dongle antenna terminal, and connecting with the dongle terminal unit; a product data communication processing unit connecting with the product data terminal; a power unit connecting with the product power terminal; an antenna unit connecting with the product antenna terminal; a control unit controlling operations of the product; and an agent unit connecting with the product data communication processing unit and the control unit, storing a first product ID so as to recognize the product, transmitting, to the control unit, a first product control signal and the second product control signal received from the dongle terminal so as to control the product, and transmitting, to the dongle data communication processing unit, information on the product and a state of operation of the product at the request of the dongle terminal.

Further, the dongle system may further include a dongle software server providing dongle software appropriate for the product to the dongle terminal so as to link the product with IoT services.

Further, the installation unit obtains the first product ID from the agent unit when the dongle terminal boots by means of power supplied by the product, obtains, from dongle software, a second product ID for a product that connected with the dongle terminal before so as to determine whether or not the first product ID matches the second product ID if the dongle software is installed in the product service software unit, and requests, to the dongle software server, dongle software matching the first product ID so as to download and install the same at the product service software unit if the first product ID does not match the second product ID.

Further, the installation unit may determine whether or not dongle software is installed in the product service software unit before determining whether or not the first product ID matches the second product ID, and if dongle software is not installed, may request, to the dongle software server, dongle software matching the first product ID so as to download and install the same at the product service software unit.

Further, the product service software unit may execute currently installed dongle software if the first product ID matches the second product ID.

Further, the installation unit may transmit, to the dongle software server, a dongle ID for recognizing the dongle terminal together with the first product ID at the time of requesting dongle software.

Further, the dongle software server takes a product ID and a service ID as a key, stores dongle software appropriate for a product ID and a service ID, and comprises a dongle software database for providing the first product ID and dongle software appropriate for a relevant service ID; a dongle database taking the dongle ID as a key and storing a product ID, a service ID and information on the dongle terminal; a product database taking a product ID as a key and storing information on a product corresponding to the product ID; and a service database taking a service ID as a key and storing information on an IoT service corresponding to the service ID at the time of requesting dongle software of the dongle terminal.

Further, if the dongle terminal downloads dongle software, the dongle software server may distribute, to a manufacturer of the product, some of the revenues earned from use of the dongle terminal.

A dongle system according to another embodiment of the present invention includes a dongle terminal, the dongle terminal including: a dongle terminal unit including a dongle data terminal for data communication with an external product, a dongle power terminal receiving power from the external product, and a dongle antenna terminal connecting with an antenna unit which is installed in the external product, wirelessly connects with an external server and the IoT, and receives a first product control signal from the external server so as to provide IoT services to the external product; a dongle data communication processing unit connecting with the dongle data terminal so as to process data communication with the external product; a wireless communication processing unit connecting with the dongle antenna terminal so as to process wireless communication with the external server and to receive the first product control signal; and a product service software unit having dongle software pre-installed therein, connecting with the wireless communication processing unit, processing the first product control signal according to the dongle software so as to transmit the same to the dongle data communication processing unit, generating a second product control signal on the basis of the dongle software so as to control the external product, and transmitting the second product control signal to the dongle data communication processing unit.

Additionally, the dongle system further includes a product connecting with the dongle terminal unit, wherein the product may include a product terminal unit including a product data terminal connecting with the dongle data terminal, a product power terminal connecting with the dongle power terminal, and a product antenna terminal connecting with the dongle antenna terminal, and connecting with the dongle terminal unit; a product data communication processing unit connecting with the product data terminal; a power unit connecting with the product power terminal; the antenna unit connecting with the product antenna terminal; a control unit controlling operations of the product; and an agent unit connecting with the product data communication processing unit and the control unit, storing a first product ID so as to recognize the product, transmitting, to the control unit, a first product control signal and the second product control signal received from the dongle terminal so as to control the product, and transmitting, to the dongle data communication processing unit, information on the product and a state of operation of the product at the request of the dongle terminal.

A dongle system according to yet another embodiment of the present invention includes a dongle terminal, the dongle terminal including: a dongle terminal unit including a dongle data terminal for data communication with an external product, and a dongle power terminal receiving power from an external product; a dongle data communication processing unit connecting with the dongle data terminal so as to process data communication with an external product; an antenna unit wirelessly connecting with an external server and the IoT, and receiving a first product control signal from the external server so as to provide IoT services to the external product; a wireless communication processing unit connecting with the antenna unit so as to process wireless communication with the external server and to receive the first product control signal; a product service software unit having a space for dongle software therein, connecting with the wireless communication processing unit, processing the first product control signal according to dongle software so as to transmit the same to the dongle data communication processing unit, generating a second product control signal on the basis of dongle software so as to control an external product, and transmitting the second product control signal to the dongle data communication processing unit; and an installation unit downloading dongle software appropriate for the external product from the external server and installing the same in the product service software unit.

Further, the dongle system further includes a product connecting with the dongle terminal unit, wherein the product may include a product terminal unit including a product data terminal connecting with the dongle data terminal and a product power terminal connecting with the dongle power terminal, and connecting with the dongle terminal unit; a product data communication processing unit connecting with the product data terminal; a power unit connecting with the product power terminal; a control unit controlling operations of the product; and an agent unit connecting with the product data communication processing unit and the control unit, storing a first product ID so as to recognize the product, transmitting, to the control unit, a first product control signal and the second product control signal received from the dongle terminal so as to control the product, and transmitting, to the dongle data communication processing unit, information on the product and a state of operations of the product at the request of the dongle terminal.

Further, the dongle system may further include a dongle software server providing dongle software appropriate for the product to the dongle terminal so as to link the product with IoT services.

Further, the installation unit obtains the first product ID from the agent unit when the dongle terminal boots by means of power supplied by the product, obtains, from dongle software, a second product ID for a product that connected with the dongle terminal before so as to determine whether or not the first product ID matches the second product ID if the dongle software is installed in the product service software unit, and requests, to the dongle software server, dongle software matching the first product ID so as to download and install the same at the product service software unit if the first product ID does not match the second product ID.

Further, the installation unit may determine whether or not dongle software is installed in the product service software unit before determining whether or not the first product ID matches the second product ID, and if dongle software is not installed, may request, to the dongle software server, dongle software matching the first product ID so as to download and install the same at the product service software unit.

Further, the product service software unit may execute currently installed dongle software if the first product ID matches the second product ID.

Further, the installation unit may transmit, to the dongle software server, a dongle ID for recognizing the dongle terminal together with the first product ID at the time of requesting dongle software.

Further, the dongle software server takes a product ID and a service ID as a key, stores dongle software appropriate for a product ID and a service ID, and at the time of requesting dongle software of the dongle terminal, includes a dongle software database providing the first product ID and dongle software appropriate for a relevant service ID; a dongle database taking the dongle ID as a key and storing a product ID, a service ID and information on the dongle terminal; a product database taking a product ID as a key and storing information on a product corresponding to the product ID; and a service database taking a service ID as a key and storing information on an IoT service corresponding to the service ID.

Further, if the dongle terminal downloads dongle software, the dongle software server may distribute, to a manufacturer of the product, some of the revenues earned from use of the dongle terminal.

### Advantageous Effects

According to embodiments of the present invention, provided is a dongle system for IoT services including a dongle which is minimized in size and independent from IoT products and IoT services.

### BRIEF DESCRIPTION OF THE DRAWINGS

FIG. 1 is a view illustrating an entire configuration of a dongle system for providing an Internet-of-Things (IoT) service, according to an embodiment of the present invention.

FIG. 2 is a view illustrating a relationship between a dongle terminal and a dongle software server in configuration, and a configuration of a dongle software server, according to an embodiment of the present invention.

FIG. 3 is a flowchart illustrating the order of operations of a dongle terminal and a dongle software server so as to provide dongle software appropriate for a product according to an embodiment of the present invention

FIG. 4 is a block diagram of a dongle system according to another embodiment of the present invention.

FIG. 5 is a block diagram of a dongle system according to yet another embodiment of the present invention.

### BEST MODE FOR CARRYING OUT THE INVENTION

Terms used in this specification will be described briefly, and the present invention will be described in detail.

Terms used in this specification are usual ones that are currently used widely considering functions of the present invention but may differ depending on the intention of those in the art to which the present invention pertains, the advent of a new technology and precedents etc. Additionally, in specific cases, this applicant arbitrarily chooses terms. In this case, the meaning of such terms will be described in detail in the description of the relevant invention. Accordingly, the terms set forth herein should not be construed as simple terms but should be defined on the basis of the meaning of the terms and context of the present invention throughout this specification.

Throughout this specification, unless explicitly described to the contrary, the term “comprise” should imply the inclusion of stated elements but not the exclusion of any other element. Further, the terms “unit”, “module” etc. set forth in this specification mean a unit for processing at least one function or operation, and the “unit”, “module” etc. may be realized as hardware or software, or a combination of hardware and software.

Below, embodiments of the present invention will be described in detail with reference to the attached drawings such that one of ordinary skill in the art to which the present invention pertains can easily realize the present invention. However, the present invention may be modified in different forms. Therefore, the present invention should not be construed as being limited to the embodiments set forth herein. Further, what is irrelevant to the description is omitted in the drawings such that the present invention is clearly described, and like reference numerals denote like elements throughout the specification.

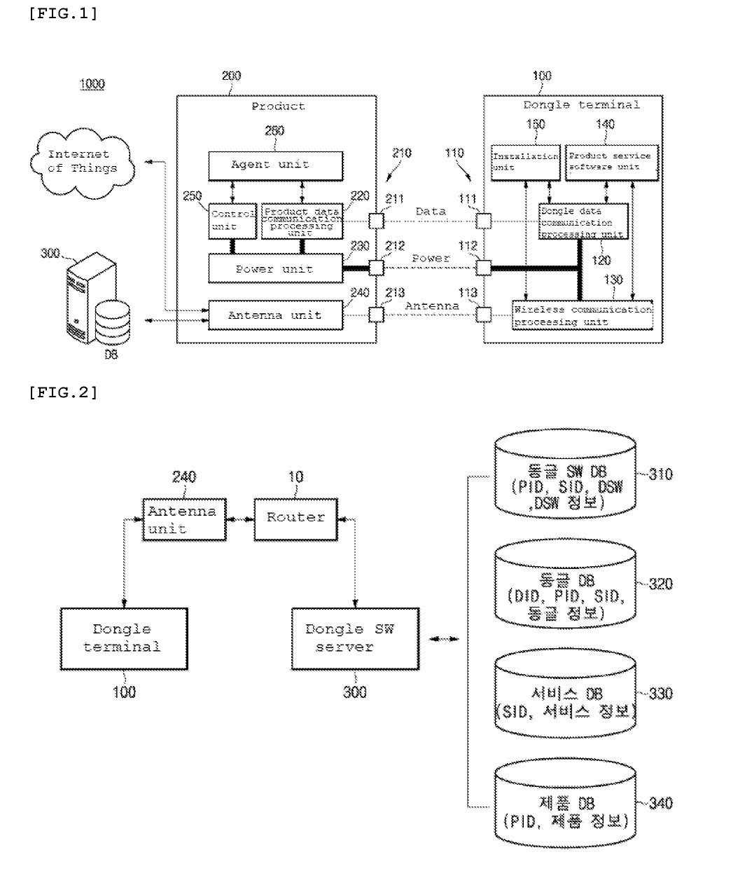

FIG. 1 is a view illustrating an entire configuration of a dongle system for providing IoT services, according to an embodiment of the present invention, and FIG. 2 is a view illustrating a relationship between a dongle terminal 100 and a dongle software server 300 in configuration, and a configuration of a dongle software server 300 according to an embodiment of the present invention.

With reference to FIGS. 1 and 2, a dongle system 1000 for providing IoT services according to an embodiment of the present invention includes an IoT service dongle terminal 100. Additionally, the dongle system 1000 may further include a product 200 into which the dongle terminal 100 is inserted, and a dongle software server 300 for providing dongle software appropriate for the product 200 to the dongle terminal 100.

The dongle terminal 100 connects with the product 200 so as to process wired and wireless communication thereby providing IoT services to the product 200. To this end, the dongle terminal 100 may include a dongle terminal unit 110, a dongle data communication processing unit 120, a wireless communication processing unit 130, a product service software unit 140 and an installation unit 150. Unlike conventional dongle terminals, a dongle terminal 100 according to an embodiment of the present invention is not equipped with an antenna for wireless communication, and a dongle terminal 100 to be used for the first time does not have a product coupled to the dongle terminal, and dongle software for linking IoT services. Detailed description regarding this will be described hereafter.

The dongle terminal unit 110 is an interface for communicating between the dongle terminal 100 and the product 200, and may include a dongle data terminal 111, a dongle power terminal 112 and a dongle antenna terminal 113.

The dongle data terminal 111, a terminal for performing data communication with the product 200, connects with the dongle data communication processing unit 120 so as to transmit, to the product 200, each product control signal of the product service software unit 140 and a data request signal of the installation unit 150, or to receive a data signal from the product 200. The dongle data terminal 111 may include one or more terminals of ‘Data+’ and ‘Data-’.

The dongle power terminal 112, a terminal for receiving power from the product 200, may receive power for the dongle terminal 100 from the product 200 when the dongle terminal unit 110 connects with the product 200. In this case, the installation unit 150 recognizes an external power supply and transmits a data request signal to the product 200 through the dongle data communication processing unit 120 so as to obtain a product ID from the product 200. The dongle power terminal 112 may include ‘VCC’ and ‘GND’ terminals.

The dongle antenna terminal 113, a terminal for wirelessly connecting with the dongle software server 300 and the IoT through an antenna unit 240 mounted onto the product 200, may connect with the wireless communication processing unit 130.

Such a dongle terminal unit 110 may be realized in various forms, for instance, in the form of the USB (Universal Serial Bus) or HDMI (High Definition Multimedia Interface). In the case of the conventional USB or HDMI, the dongle antenna terminal 113 is expanded and realized, or a separate terminal pin is converted into a means for antenna communication so as to transmit and receive a control signal.

The dongle data communication processing unit 120 connects with the dongle data terminal 111 so as to process data communication with the product 200. Further, the dongle data communication processing unit 120 connects with the product service software unit 140 and the installation unit 150 respectively, receives a second product control signal of the product service software unit 140 and a data request signal of the installation unit 150, performs preset communication processing and then transmits the same to the dongle data terminal 111.

The wireless communication processing unit 130 connects with the dongle antenna terminal 113 so as to process wireless communication through the antenna unit 240. Further, the wireless communication processing unit 130 receives information on a product ID of the product service software unit 140 and a dongle software request signal, information on a dongle ID etc. of the installation unit 150 so as to transmit the same to the antenna unit 240 through preset signal processing. Further, the wireless communication processing unit 130, through the antenna unit 240, receives certain data or signals etc. from an external server for providing IoT services and transmits the same to the product service software unit 140.

Dongle software for providing IoT services is installed at the product service software unit 140 transmits, to the dongle data communication processing unit 120, a first product control signal received through the wireless communication processing unit 130 and transmits, to the dongle data communication processing unit 120, a second product control signal generated through dongle software. The first product control signal may denote a signal for controlling operations of the product 200 so as to provide IoT services.

The dongle software itself may output a second product control signal so as to control operations of the product 200 on the basis of an algorithm that is programed in advance. For instance, if the product 200 is an air conditioner, the dongle software receives information on temperatures near the air conditioner from the air conditioner or devices near the air conditioner, and generates a second product control signal so as to periodically change a set temperature of the air conditioner on the basis of the received information on temperatures near the air conditioner. As described above, the product service software unit 140 may control operations of the product 200 on the basis of the dongle software.

Further, the dongle software installed at the product service software unit 140 stores a second product ID (PID2) and a service ID (SID) so as to recognize a product having connected with the dongle terminal before.

The installation unit 150 may download dongle software appropriate for the product 200 from the dongle software server 300 and install the same at the product service software unit 140. To this end, the installation unit 150 may determine whether or not dongle software is installed at the product service software unit 140, whether or not the installed dongle software is appropriate for the product 200, and may request dongle software to the dongle software server 300.

More specifically, the installation unit 150 obtains a first product ID (PID1) from an agent unit 260 of the product 200 when the dongle terminal 100 boots by means of power supplied by the product 200, determines that dongle software is not installed at the product service software unit 140, requests, to the dongle software server 300, dongle software matching the first product ID (PID1), downloads the same, and installs the same at the product service software unit 140. At the time of requesting download of dongle software, the installation unit 150 may transmit the first product ID (PID1) and a dongle ID (DID) together with a dongle software download request signal.

Further, when determining that dongle software is installed at the product service software unit 140, the installation unit 150 obtains a second product ID (PID2) from the installed dongle software so as to determine whether or not the first product ID (PID1) matches the second product ID (PID2).

In this case, if the first product ID (PID1) does not match the second product ID (PID2), the installation unit 150 requests, to the dongle software server 300, dongle software matching the first product ID (PID1), downloads the same and installs the same at the product service software unit 140. At the time of requesting download of dongle software, the installation unit 150 may transmit the first product ID (PID1) and a dongle ID (DID) together with a dongle software download request signal.

Meanwhile, if the first product ID (PID1) matches the second product ID (PID2), the product service software unit 140 may execute installed dongle software.

The product 200 may include consumer electronics or electronic devices available for IoT services and various elements for communication and a link with the dongle terminal 100. Specifically, the product 200 may include a product terminal unit 210, a product data communication processing unit 220, a power unit 230, an antenna unit 240, a control unit 250, and an agent unit 260.

The product terminal unit 210 may include a product data terminal 211, a product power terminal 212 and a product antenna terminal 213, and may connect with the dongle terminal unit 110.

The product data terminal 211 connects with the product data communication processing unit 220 such that the product data terminal 211 connects with the dongle data terminal 111 when connecting with the dongle terminal unit 110. The product data terminal 211 may form a communication interface between the product data communication processing unit 220 and the dongle data communication processing unit 120 together with the dongle data terminal 111.

The product power terminal 212 connects with the power unit 230 such that the product data terminal 211 connects with the dongle power terminal 112 when connecting with the dongle terminal unit 110. The product power terminal 212 may form an interface for supplying power from the product 220 to the dongle terminal 100 together with the dongle power terminal 112.

The product antenna terminal 213 connects with the antenna unit 240 such that the product antenna terminal 213 connects with the product antenna terminal 213 when connecting with the dongle terminal unit 110. The product antenna terminal 213 may form a connection interface between the antenna unit 240 and the wireless communication processing unit 130 together with the dongle antenna terminal 113.

Such a product terminal unit 210 may be realized in the form of the USB. In the case of the conventional USB, the product antenna terminal 213 is expanded and realized, or a separate terminal pin is converted into a means for antenna communication so as to transmit and receive a control signal.

The product data communication processing unit 220 connects with the product data terminal 211 so as to perform communication processing of data or information transmitted and received among the control unit 250, the agent unit 260 and the dongle terminal 100.

The power unit 230 may receive power for the product 200 from external power and provide power to the dongle terminal 100 through the product power terminal 212.

The antennal unit 240 may be installed in the product 200, as a means to wirelessly connect the dongle terminal 100 with the dongle software sever 300 and the IoT. The antenna unit 240 may connect with the wireless communication processing unit 130 of the dongle terminal 100 through the product antenna terminal 213 and the dongle antenna terminal 113, and may wirelessly connect with the dongle software server 300 and the IoT through an indoor router 10.

The control unit 250, a means to control operations of the product 200, connects with the agent unit 260 so as to control operations of the product 200 according to a first product control signal or a second product control signal delivered by the agent unit 260. Further, if a sensor connects with the interior or exterior of the product 200, the control unit receives information sensed by the sensor so as to deliver the information to the agent unit 260.

The agent unit 260 connects with the control unit 250 and the product data communication processing unit 220 so as to process a request for data, received through the product data communication processing unit 220 and made by the dongle terminal and to deliver product control signals, and extracts information on a state of the product 200 from the control unit 250 so as to deliver the information to the product data communication processing unit 220. For instance, if the dongle terminal 100 requests a second product ID of the product 200, the agent unit 260 may provide a stored second product ID (PID2) to the dongle terminal 100, deliver a product control signal, received from the dongle terminal 100, to the control unit 250, obtain information on the state of the product 200 (operation, sensing etc.) or information on the results of control according to the product control signal etc. from the control unit 250 so as to deliver the same to the product data communication processing unit 220.

The dongle software server 300 may wirelessly connect through the antenna unit 240 and provide, to the dongle terminal 100, dongle software appropriate for the product 200 so as to link the product 200 with IoT services. To this end, the dongle software server 300 may include a dongle software database 310, a dongle database 320, a service database 330 and a product database 340.

The dongle software database 310 may take a product ID (PID) and service ID (SID) as a key and store dongle software (DSW) appropriate for the product ID (PID) and the service ID (SID). Specifically, the dongle software database 310 may input a product ID (PID) and a service ID (SID) and provide dongle software (DSW) and information on dongle software (DSW) appropriate for a relevant product and service.

The product ID (PID) is information used for the dongle software to recognize a product having connected with the dongle terminal before. For instance, if an air conditioner manufactured by S electronics, and an air conditioner manufactured by L electronics were connected with the dongle terminal before, dongle software is usually different. Accordingly, the air conditioner manufactured by S electronics, and the air conditioner manufactured by L electronics have different product IDs. Meanwhile, if a piece of dongle software is used for an air conditioner and a vacuum cleaner manufactured by S electronics, the dongle software may have an identical product ID (PID).

The service ID (SID) is information used for the dongle software to recognize a service having connected with the dongle terminal before. For instance, a service provided by S service provider and dongle software of L service provider are usually different. Accordingly, dongle software may have different service IDs.

The dongle software (DSW) differs depending on a product ID (PID) and a service ID (SID). For instance, dongle software (DSW) for linking an air conditioner of S electronics with a service of S service provider is different from dongle software (DSW) for linking an air conditioner of S electronics with a service of L service provider. The dongle software database, as described above, may store dongle software (DSW) matching a product ID (PID) and a service ID (SID).

Accordingly, when the installation unit 150 of the dongle terminal 100 requests dongle software to the dongle software server 300 with a first product ID and a dongle ID, the dongle database 320 provides a service ID appropriate for the dongle ID, and the dongle software database 310 provides dongle software appropriate for the first product ID and the service ID. The dongle database 320 takes a dongle ID (DID) as a key and stores a product ID (PID) of a product connected with the dongle terminal and a service ID (SID) of a service provided by the dongle terminal. Accordingly, when the dongle terminal requests dongle software necessary for a product with a product ID (PID), the dongle database 320 confirms a service ID (SID) and transmits dongle software appropriate for the product ID (PID) and service ID (SID). In this case, the dongle terminal stores the product ID (PID) in the dongle database 320 because the dongle terminal connects with the product ID (PID).

The dongle database 320 may take a dongle ID (DID) as a key and store a product ID (PID), a service ID (SID) and information on the dongle terminal. Specifically, the dongle database 320 may provide a product ID (PID) of a product 200 connected with the dongle terminal 100, a service ID (SID) of an Internet service linked with the product 200 and information on the dongle terminal 100 by using a dongle ID (DID) that is received when the dongle terminal 100 requests download of software. Herein, the information on the dongle terminal 100 may include identification information of the dongle terminal 100 and information on a customer who purchases the dongle terminal. Herein, the information on a customer may include a name, a contact address (email, home address, phone number etc.), an account etc. so as to charge the customer fees for dongle software downloaded by the customer.

Accordingly, when the dongle terminal 100 downloads dongle software, the dongle software server 300 may distribute, to a manufacturer of a product (e.g. S electronics, L electronics etc.), some of the revenues earned from the use of a dongle ID.

The service database 330 may take a service ID (SID) as a key and store information on IoT services corresponding to the service ID (SID).

The product database 340 may take a product ID (PID) as a key and store information on a product corresponding to the product ID (PID).

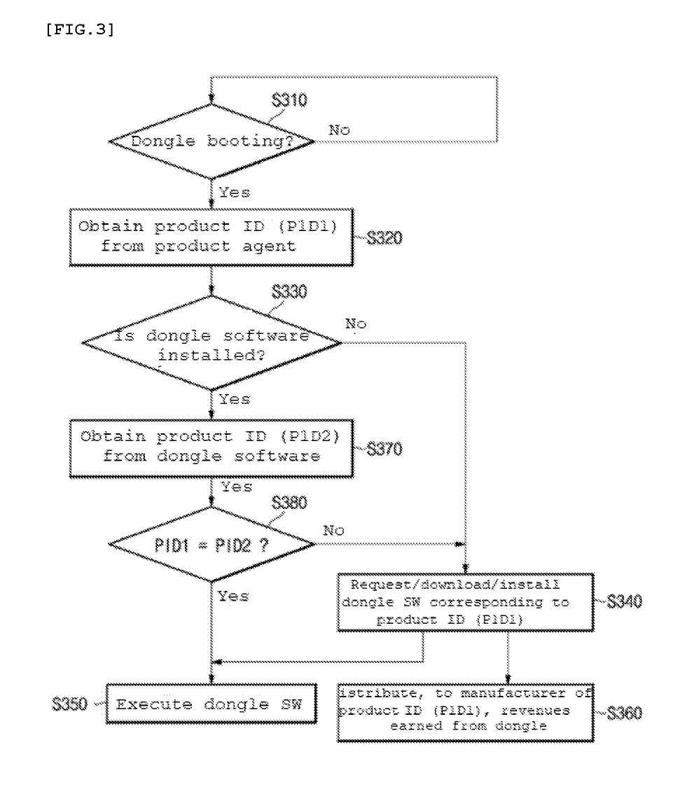

FIG. 3 is a flow chart illustrating the order of operations of a dongle terminal 100 and a dongle software server 300 according to an embodiment of the present invention so as to provide dongle software appropriate for a product.

First, when a dongle terminal unit 110 connects with a product terminal unit 210, a dongle terminal 100 may receive power from a product 200 so as to boot (S310).

As described above, when the dongle terminal 100 boots, an installation unit 150 may request a product ID to an agent unit 260 of the product 200 and obtain a first product ID (PID1) from the agent unit 260 (S320).

Afterwards, the installation unit 150 may determine whether or not dongle software for product services is currently installed in the dongle terminal 100 (S330). If the dongle terminal 100 is used for the first time for the product 200 after purchased, dongle software is not installed at a product service software unit 140, and if the dongle terminal 100 was used before for the product after purchased, dongle software appropriate for a previous product is installed. Accordingly, the installation unit may determine whether or not dongle software itself is installed before downloading dongle software appropriate for a currently connected product 200, and then, if dongle software is not installed, may request dongle software appropriate for the product 200 so as to download the same (S340).

The dongle software server 300 transmits, to the dongle terminal 100, the first product ID (PID1) received at the request of the dongle terminal 100 for download of dongle software, and dongle software appropriate for a service ID (SID) matching the first product ID (PID1), and the installation unit 150 downloads the dongle software so as to install the same at the product service software unit 140 (S340). Herein, the dongle terminal 100 and the dongle software server 300 are wirelessly connected through an antenna unit 240 so as to transmit and receive necessary data or information.

As described above, when a new piece of dongle software is installed, the installed dongle software may be executed by the product service software unit 140 (S350).

Herein, the dongle software server 300 may distribute, to a manufacturer of the product 200, revenues earned from the use of the dongle terminal 100 after the download of the dongle software (S360). A customer using the dongle terminal 100 is identified by a dongle ID (DID).

Meanwhile, if product service software is installed at the product service software unit 140, the installation unit 150 may obtain a second product ID (PID2) from the dongle software of the product service software unit 140 (S370), and may compare and match the obtained second product ID (PID2) and the first product ID (PID1) so as to determine whether or not the obtained second product ID (PID2) matches the first product ID (PID1) (S380). That is, in step 380, the installation unit 150 may determine whether or not the second product ID (PID2) matches the first product ID (PID1) so as to determine whether or not dongle software, currently installed at the product service software unit 140, may be used to a product 200 currently connected with the dongle terminal 100.

If the installation unit 150 determines that the second product ID (PID2) does not match the first product ID (PID1), the installation unit may transmit the first product ID (PID1) to the dongle software server 300 and may request download of dongle software. The dongle software server 300 may transmit, to the dongle terminal 100, the received first product ID (PID1) and dongle software appropriate for a service ID matching the first product ID (PID1) at the request of the dongle terminal 100, and the installation unit 150 may download and install the dongle software in the product service software unit 140 (S340). Additionally, the product service software unit 140 may convert a second product ID (PID2) stored in relevant software into a first product ID (PID1) and store the converted first product ID (PID1). During this process, a service ID (SID) matching the second product ID (PID2) may be converted and the converted service ID may be stored.

As described above, in this case, if the dongle terminal downloads dongle software, the dongle software server 300 may distribute, to a manufacturer of the product 200, revenues earned from the use of the dongle terminal 100 (S360).

If the installation unit 150 determines that the second product ID (PID2) matches the first product ID (PID1), the installation unit may execute dongle software installed in the product service software unit 140 (S380).

Below, examples of how a dongle system 1000 of the present invention is used will be described.

For instance, a user has purchased an air conditioner of S electronics and an air cleaner of L electronics that are capable of connecting with a dongle terminal, and two dongle terminals available for smart home services of S communication company.

When the purchased dongle terminals respectively connect with the air conditioner and the air cleaner, each of the dongle terminals may download, from a dongle software server, service software of S communication company for the air conditioner of S electronics and service software of S communication company for the air cleaner of L electronics. In this case, a certain amount of revenue earned from the download of the dongle software may be distributed respectively to S electronics and L electronics.

The user may use the air conditioner of S electronics and the air cleaner of L electronics with a smart home service of S communication company. For instance, the user may remotely set temperature of the air conditioner or may remotely turn off the air cleaner by using an application for the air conditioner and air cleaner installed onto the user's smart phone or tablet PC. Herein, when the user sets temperature of the air conditioner with the application for the air conditioner, a relevant communication service server wirelessly transmits an instruction to set temperature of the air conditioner, a product service software unit of a relevant dongle terminal receives the instruction through an antenna unit installed in the product. In this case, a communication protocol that transmits the instruction to set temperature of the air conditioner applies a method determined by the smart home service of S communication company.

The product service software unit transmits the instruction to set temperature of the air conditioner to the product through a data communication processing unit, and a data communication processing unit of the product may transmit the instruction to an agent unit. The agent unit may control operations or functions (temperature setting) of the product through a control unit according to the instruction. In this case, a communication protocol that transmits the instruction to set temperature of the air conditioner applies a method determined by S electronics.

Meanwhile, the user has purchased a new washing machine manufactured by S electronics. If the user applies the dongle terminal for the air cleaner to the new washing machine, a product ID of the washing machine may differ from a product ID of dongle software installed onto the dongle terminal may differ. In general, a dongle terminal provides a service for a product and communication service. Accordingly, the dongle terminal does not work. In this case, the user has to purchase a new dongle terminal.

According to this embodiment, dongle information stored in the dongle software server may be initialized such that new dongle software is downloaded onto the relevant dongle terminal, thereby making it possible to reduce inconvenience and costs caused by purchasing a new dongle terminal except the cost of downloading new dongle software.

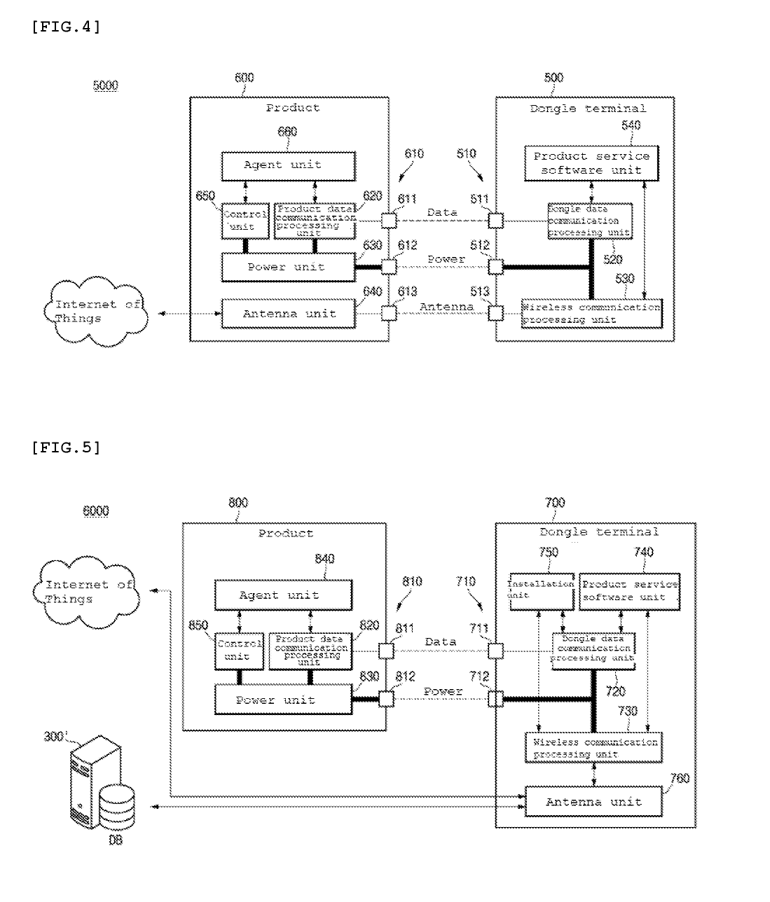

FIG. 4 is a block diagram illustrating a dongle system according to another embodiment of the present invention.

With reference to FIG. 4, a dongle system 5000 according to another embodiment of the present invention includes a dongle terminal 500 including a dongle terminal unit 510, a dongle data communication processing unit 520, a wireless communication processing unit 530 and a product service software unit 540. Additionally, the dongle system 5000 may further include a product 600, and the product 600 may include a product terminal unit 610, a product data communication processing unit 620, a power unit 630, an antenna unit 640, a control unit 650 and an agent unit 660.

According to the dongle system 5000 according to another embodiment of the present invention illustrated in FIG. 4, when the dongle terminal 500 connects with the product 600, the dongle terminal 500 is not configured to download new dongle software appropriate for the product 600, but to use dongle software installed in advance onto the product service software unit 540, compared to the dongle system according to an embodiment of the present invention. Herein, the dongle software means software appropriate for the product 600. Accordingly, the dongle terminal 500 may exclude an installation unit 150, contrary to the dongle system according to an embodiment of the present invention, and the antenna unit 640 may function as a means to connect with an external server for the use of IoT services.

The above-described technical configuration of the dongle system 5000 according to another embodiment of the present invention is different from that of the dongle system 1000 according to an embodiment of the present invention. The other configurations of the dongle system 5000 according to another embodiment of the present invention that are the same as those of the dongle system 1000 according to an embodiment of the present invention will be omitted.

FIG. 5 is a block diagram of a dongle system according to yet another embodiment of the present invention.

With reference to FIG. 5, a dongle system 6000 according to yet another embodiment of the present invention includes a dongle terminal 700. Additionally, the dongle system 6000 may further include a product 800 and a dongle software server 300′.

The dongle terminal 700 may include a dongle terminal unit 710, a dongle data communication processing unit 720, a wireless communication processing unit 730 and a product service software unit 740, an installation unit 750 and an antenna unit 760.

The product 800 may include a product terminal unit 810, a product data communication processing unit 820, a power unit 830, an agent unit 840, a control unit 850.

According to a dongle system 6000 according to yet another embodiment of the present invention, an antenna unit 760 is not installed in the product 800, compared to the dongle system according to an embodiment of the present invention. The antenna unit 760 is configured to detachably connect with the dongle terminal 700 or to be installed in the dongle terminal 700. Accordingly, the dongle terminal unit 710 excludes a dongle antennal terminal 113, and the product terminal unit 810 may exclude a product antenna terminal 213, contrary to the dongle system according to an embodiment of the present invention.

Except the above-described differences between the dongle system 6000 according to yet another embodiment of the present invention and the dongle system according to an embodiment of the present invention, a dongle data communication processing unit 720, a wireless communication processing unit 730, a product service software unit 740, an installation unit 750, a product data communication processing unit 820, a power unit 830, an agent unit 840 and a control unit 850 of the dongle system according to yet another embodiment of the present invention and the dongle system according to an embodiment of the present invention have similar configurations. In particular, according to the dongle system according to yet another embodiment of the present invention, when the dongle terminal 700 connects with the product 800, dongle software appropriate for the product 800 is downloaded from the dongle software server 300′ and installed in the dongle terminal 700 like the dongle system according to an embodiment of the present invention. Accordingly, description regarding this configuration will be omitted.

According to embodiments of the present invention, an antenna for a wireless connection of a dongle is installed in a product that will link with IoT services through a dongle, unlike a convention way in which an antenna is separately installed at the exterior of a dongle or inside a dongle, thereby making it possible to reduce the size of a dongle.

Further, dongle software that is dependently installed in a product and an IoT service is not installed at the time of manufacturing a dongle. Instead, when a dongle connects with a product, software appropriate for the product and IoT service is downloaded from a dongle software server and installed. As a result, it is possible to provide an individual dongle to each product.

The embodiments of a dongle system for providing IoT services according to the present invention have been described. However, the embodiments are provided only as examples to carry out the dongle system. It should be understood that other modifications and changes may be made, as claimed in the appended claims, by one of ordinary skill in the art to which the present invention pertains without departing from the gist of the invention and that the modifications and changes are included in the technical spirit of the present invention.

1. A dongle system comprising a dongle terminal,
the dongle terminal comprising:
a dongle terminal unit comprising a dongle data terminal for data communication with an external product, a dongle power terminal receiving power from the external product, and a dongle antenna terminal connecting with an antenna unit which is installed in the external product, wirelessly connects with an external server and the Internet of Things (IoT), and receives a first product control signal from the external server so as to provide IoT services to the external product;
a dongle data communication processing unit connecting with the dongle data terminal so as to process data communication with the external product;
a wireless communication processing unit connecting with the dongle antenna terminal so as to process wireless communication with the external server and to receive the first product control signal;
a product service software unit having a space for a dongle software therein, connecting with the wireless communication processing unit, processing the first product control signal according to the dongle software so as to transmit the same to the dongle data communication processing unit, generating a second product control signal on the basis of the dongle software so as to control the external product, and transmitting the second product control signal to the dongle data communication processing unit; and
an installation unit downloading the dongle software appropriate for the external product from the external server and installing the same in the product service software unit.

2. The dongle system according to claim 1, further comprising a product connecting with the dongle terminal unit,
wherein the product comprises a product terminal unit comprising a product data terminal connecting with the dongle data terminal, a product power terminal connecting with the dongle power terminal and a product antenna terminal connecting with the dongle antenna terminal, and connecting with the dongle terminal unit;
a product data communication processing unit connecting with the product data terminal;
a power unit connecting with the product power terminal;
an antenna unit connecting with the product antenna terminal;
a control unit controlling operations of the product; and
an agent unit connecting with the product data communication processing unit and the control unit, storing a first product ID so as to recognize the product, transmitting, to the control unit, the first product control signal and the second product control signal received from the dongle terminal so as to control the product, and transmitting, to the dongle data communication processing unit, information on the product and a state of operations of the product at the request of the dongle terminal.

3. The dongle system according to claim 2, further comprising: a dongle software server for providing the dongle software appropriate for the product to the dongle terminal so as to link the product with IoT services.

4. The dongle system according to claim 3, wherein the installation unit obtains the first product ID from the agent unit when the dongle terminal boots by means of power supplied by the product, obtains, from the dongle software, a second product ID for a product that connected with the dongle terminal before so as to determine whether or not the first product ID matches the second product ID if the dongle software is installed in the product service software unit, and requests, to the dongle software server, the dongle software matching the first product ID so as to download and install the same at the product service software unit if the first product ID does not match the second product ID.

5. The dongle system according to claim 4, wherein the installation unit determines whether or not the dongle software is installed in the product service software unit before determining whether or not the first product ID matches the second product ID, and if the dongle software is not installed, requests, to the dongle software server, the dongle software matching the first product ID so as to download and install the same at the product service software unit.

6. The dongle system according to claim 5, wherein the product service software unit executes currently installed the dongle software if the first product ID matches the second product ID.

7. The dongle system according to claim 5, wherein the installation unit transmits, to the dongle software server, a dongle ID for recognizing the dongle terminal together with the first product ID at the time of requesting the dongle software.

8. The dongle system according to claim 5, wherein the dongle software server takes a product ID and a service ID as a key, stores the dongle software appropriate for a product ID and a service ID, and comprises a dongle software database for providing the first product ID and the dongle software appropriate for a relevant service ID; a dongle database taking the dongle ID as a key and storing a product ID, a service ID and information on the dongle terminal; a product database taking a product ID as a key and information on a product corresponding to the product ID; and a service database taking a service ID as a key and storing information on an IoT service corresponding to the service ID at the time of requesting the dongle software of the dongle terminal.

9. The dongle system according to claim 8, wherein when the dongle terminal downloads the dongle software, the dongle software server distributes, to a manufacturer of the product, some of the revenues earned from use of the dongle terminal.

10. A dongle system comprising a dongle terminal,
the dongle terminal comprising:
a dongle terminal unit comprising a dongle data terminal for data communication with an external product, a dongle power terminal receiving power from the external product, and a dongle antenna terminal connecting with an antenna unit which is installed in the external product, wirelessly connects with an external server and the IoT, and receives a first product control signal from the external server so as to provide IoT services to the external product;
a dongle data communication processing unit connecting with the dongle data terminal so as to process data communication with the external product;
a wireless communication processing unit connecting with the dongle antenna terminal so as to process wireless communication with the external server and to receive the first product control signal; and
a product service software unit having a dongle software pre-installed therein, connecting with the wireless communication processing unit, processing the first product control signal according to the dongle software so as to transmit the same to the dongle data communication processing unit, generating a second product control signal on the basis of the dongle software so as to control the external product, and transmitting the second product control signal to the dongle data communication processing unit.

11. The dongle system according to claim 10, further comprising a product connecting with the dongle terminal unit,
wherein the product comprises a product terminal unit comprising a product data terminal connecting with the dongle data terminal, a product power terminal connecting with the dongle power terminal, and a product antenna terminal connecting with the dongle antenna terminal, and connecting with the dongle terminal unit;
a product data communication processing unit connecting with the product data terminal;
a power unit connecting with the product power terminal;
the antenna unit connecting with the product antenna terminal;
a control unit controlling operations of the product; and
an agent unit connecting with the product data communication processing unit and the control unit, storing a first product ID so as to recognize the product, transmitting, to the control unit, a first product control signal and the second product control signal received from the dongle terminal so as to control the product, and transmitting, to the dongle data communication processing unit, information on the product and a state of operations of the product at the request of the dongle terminal.

12. A dongle system comprising a dongle terminal,
the dongle terminal comprising:
a dongle terminal unit comprising a dongle data terminal for data communication with an external product, and a dongle power terminal receiving power from an external product;
a dongle data communication processing unit connecting with the dongle data terminal so as to process data communication with an external product;
an antenna unit wirelessly connecting with an external server and the IoT, and receiving a first product control signal from the external server so as to provide IoT services to the external product;
a wireless communication processing unit connecting with the antenna unit so as to process wireless communication with the external server and to receive the first product control signal;
a product service software unit having a space for a dongle software therein, connecting with the wireless communication processing unit, processing the first product control signal according to the dongle software so as to transmit the same to the dongle data communication processing unit, generating a second product control signal on the basis of the dongle software so as to control an external product, and transmitting the second product control signal to the dongle data communication processing unit; and
an installation unit downloading the dongle software appropriate for the external product from the external server and installing the same in the product service software unit.

13. The dongle system according to claim 12,
the dongle system further comprising a product connecting with the dongle terminal unit,
the product comprising:
a product terminal unit comprising a product data terminal connecting with the dongle data terminal and a product power terminal connecting with the dongle power terminal, and connecting with the dongle terminal unit;
a product data communication processing unit connecting with the product data terminal;
a power unit connecting with the product power terminal;
a control unit controlling operations of the product; and
an agent unit connecting with the product data communication processing unit and the control unit, storing a first product ID so as to recognize the product, transmitting, to the control unit, a first product control signal and the second product control signal received from the dongle terminal so as to control the product, and transmitting, to the dongle data communication processing unit, information on the product and a state of operations of the product at the request of the dongle terminal.

14. The dongle system according to claim 13,
wherein the dongle system further comprises a dongle software server providing the dongle software appropriate for the product to the dongle terminal so as to link the product with IoT services.

15. The dongle system according to claim 14,
wherein the installation unit obtains the first product ID from the agent unit when the dongle terminal boots by means of power supplied by the product, obtains, from the dongle software, a second product ID for a product that connected with the dongle terminal before so as to determine whether or not the first product ID matches the second product ID if the dongle software is installed in the product service software unit, and requests, to the dongle software server, the dongle software matching the first product ID so as to download and install the same at the product service software unit if the first product ID does not match the second product ID.

16. The dongle system according to claim 15,
wherein the installation unit determines whether or not the dongle software is installed in the product service software unit before determining whether or not the first product ID matches the second product ID, and if the dongle software is not installed, requests, to the dongle software server, the dongle software matching the first product ID so as to download and install the same at the product service software unit.

17. The dongle system according to claim 16,
wherein the product service software unit executes currently installed the dongle software if the first product ID matches the second product ID.

18. The dongle system according to claim 16,
wherein the installation unit transmits, to the dongle software server, a dongle ID for recognizing the dongle terminal together with the first product ID at the time of requesting the dongle software.

19. The dongle system according to claim 16,
wherein the dongle software server takes a product ID and a service ID as a key, stores the dongle software appropriate for a product ID and a service ID, and at the time of requesting the dongle software of the dongle terminal, comprises a dongle software database providing the first product ID and the dongle software appropriate for a relevant service ID; a dongle database taking the dongle ID as a key and storing a product ID, a service ID and information on the dongle terminal; a product database taking a product ID as a key and storing information on a product corresponding to the product ID; and a service database taking a service ID as a key and storing information on an IoT service corresponding to the service ID.

20. The dongle system according to claim 19,
wherein the dongle software server distributes, to a manufacturer of the product, some of the revenues earned from use of the dongle terminal if the dongle terminal downloads the dongle software.
